(19) United States
(12) Patent Application Publication
(10) Pub. No.: US 2016/0041375 A1
(43) Pub. Date: Feb. 11, 2016

(54) ULTRA-COMPACT MICROSCOPE WITH AUTOFOCUSING

(71) Applicant: General Electric Company, Schenectady, NY (US)

(72) Inventors: Chun Zhan, Niskayuna, NY (US); Robert John Filkins, Niskayuna, NY (US); Juntao Wu, Niskayuna, NY (US)

(21) Appl. No.: 14/453,638

(22) Filed: Aug. 7, 2014

(51) Int. Cl. G02B 21/00; H04N 5/232; H04N 5/225

(52) U.S. Cl. CPC G02B 21/0008; H04N 5/2259; H04N 5/23203

(57) ABSTRACT

An ultra-compact microscope configured to image at least a portion of a biological sample is provided. The ultra-compact microscope includes an illumination source configured to provide illumination beams to image at least the portion of the biological sample. The ultra-compact microscope further includes an image sensor configured to acquire emitted signals from at least the portion of the biological sample. Moreover, the ultra-compact microscope includes an objective lens operatively coupled to the image sensor and configured to direct emitted signals from the biological sample to the image sensor. Additionally, the ultra-compact microscope includes a micro-motion control assembly operatively coupled to the image sensor and configured to provide dynamic translational motion, dynamic tilting motion, or both to the image sensor at least during scanning of the biological sample.

### BACKGROUND

Embodiments of the present specification relate to tissue pathology, and more particularly to systems and methods for screening of biological samples.

Typically, microscopes are used for acquiring information regarding one or more properties or aspects of biological samples. Traditional fluorescent microscopes require sophisticated and expensive optical lenses, one or more motion control stages, and a charge coupled device (CCD) camera. Further, the traditional fluorescent microscopes utilize bulky and expensive high precision actuators to scan objective lens for autofocusing. As a result, the traditional fluorescent microscopes are bulky, slow and cost ineffective. These attributes of the traditional fluorescent microscopes usually confine the use of traditional fluorescent microscopes to laboratory settings, thereby restricting accessibility to such microscopes on the field, for example.

Further, generally, specimens mounted on or contained within microscope media are three-dimensional (3D) objects. However, digital microscopy has been limited by partial capturing of volumes that represent only a subset of the total volume of the specimens mounted on or contained within the microscope medium. This is especially the case in applications where high spatial resolution is required. One reason for this constraint is the limited field of view, or volume of the media that may be digitized at any one time with a conventional microscope apparatus.

Moreover, sampling in the Z dimension (the distance in the Z-axis in which objects are in sharp focus) is typically determined by an optical depth of field of the microscope. By way of example, at a 40 objective magnification, the depth of field of conventional microscope optics is only of the order of 1 micrometer. Another disadvantage of a single plane of focus systems is a lack of scalability. In order to convert these systems to capture multiple planes of focus, it is necessary to perform one additional scan of the entire specimen for each additional plane of focus required. Further, these additional scans in the multiple planes of focus need to be performed in a time sequential manner. Hence, the time penalty associated with this approach is multiplicative. Additionally, each focal plane needs to be co-registered to produce an accurate three-dimensional image. Further, co-registering of each focal plane is a complex operation due to accumulation of positional errors during each scan.

### BRIEF DESCRIPTION

In accordance with aspects of the present specification, an ultra-compact microscope configured to image at least a portion of a biological sample is provided. The ultra-compact microscope includes an illumination source configured to provide illumination beams to image at least the portion of the biological sample. The ultra-compact microscope further includes an image sensor configured to acquire emitted signals from at least the portion of the biological sample. Moreover, the ultra-compact microscope includes an objective lens operatively coupled to the image sensor and configured to direct emitted signals from the biological sample to the image sensor. Additionally, the ultra-compact microscope includes a micro-motion control assembly operatively coupled to the image sensor and configured to provide dynamic translational motion, dynamic tilting motion, or both to the image sensor at least during scanning of the biological sample.

In accordance with another aspect of the present specification, an imaging system for imaging at least a portion of the biological sample is provided. The imaging system includes an ultra-compact microscope having an illumination source configured to provide illumination beams to image at least the portion of the biological sample. The ultra-compact microscope further includes an image sensor configured to acquire emitted signals from at least the portion of the biological sample. Moreover, the ultra-compact microscope includes an objective lens operatively coupled to the image sensor and configured to direct emitted signals from the biological sample to the image sensor. Additionally, the ultra-compact microscope includes a micro-motion control assembly operatively coupled to the image sensor and configured to provide dynamic translational motion, dynamic tilting motion, or both to the image sensor at least during scanning of the biological sample. Further, the imaging system includes a signal processing unit operatively coupled to the ultra-compact microscope and configured to process the emitted signals acquired by the image sensor. Moreover, the imaging system includes a controller unit configured to control the micro-motion control assembly.

In accordance with yet another aspect of the present specification, a method for imaging a biological sample is provided. The method includes providing a biological sample disposed on an analysis surface and providing an ultra-compact microscope operatively coupled to the analysis surface. The method further includes illuminating at least a portion of the biological sample using an illumination source of the ultra-compact microscope. Moreover, the method includes scanning at least a portion of the biological sample using an image sensor and a micro-motion control assembly of the ultra-compact microscope. Additionally, the method includes acquiring emitted signals from at least the portion of the biological sample by the image sensor of the ultra-compact microscope. Further, the method includes processing the acquired emitted signals to form an image of at least the portion of the biological sample.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic representation of an exemplary ultra-compact microscope, in accordance with aspects of the present specification;

FIG. 2 is a perspective view of an exemplary ultra-compact microscope, in accordance with aspects of the present specification;

FIG. 3 is a perspective view of a portion of an ultra-compact microscope having actuators and an image sensor, in accordance with aspects of the present specification;

FIG. 4 is perspective view of the portion of the ultra-compact microscope of FIG. 3 disposed in a housing, in accordance with aspects of the present specification;

FIG. 5 is a perspective view of an exemplary adapter configured to couple a plurality of actuators to an image sensor, in accordance with aspects of the present specification;

FIG. 6 is a perspective view of a portion of a plurality of actuators configured to be coupled to the adapter of FIG. 5, in accordance with aspects of the present specification;

FIG. 7 is a perspective view of a portion of an exemplary ultra-compact microscope, where the image sensor of FIG. 5 is coupled to the plurality of actuators of FIG. 6 using the adapter of FIG. 5, in accordance with aspects of the present specification;

FIG. 8A is a perspective view of an integrated system employing an ultra-compact microscope operatively coupled to a sample stage, in accordance with aspects of the present specification;

FIG. 8B is a perspective view of the sample stage of FIG. 8A, where the sample stage includes two linear stages, in accordance with aspects of the present specification;

FIG. 9 is a schematic representation of an exemplary imaging system having an ultra-compact microscope, in accordance with aspects of the present specification;

FIG. 10 is a schematic representation of a portion of an exemplary multi-head ultra-compact microscope, in accordance with aspects of the present technique; and

FIG. 11 is a flow chart of an exemplary method for imaging a biological sample to identify a region of interest, in accordance with aspects of the present specification.

### DETAILED DESCRIPTION

Embodiments of the present specification relate to an ultra-compact microscope. In certain embodiments, the ultra-compact microscope is configured to scan a biological sample to identify one or more regions of interest. In one embodiment, the ultra-compact microscope is configured to provide bright-field imaging, fluorescent imaging, epi-fluorescent imaging, phase contrast imaging, or combinations thereof. Further, the ultra-compact microscope may be used for three-dimensional (3D) imaging. Moreover, the ultra-compact microscope is configured to provide autofocusing in whole slide imaging of the biological sample to achieve sharply focused images using the ultra-compact microscope of the present specification.

In certain embodiments, the ultra-compact microscope may be used for identifying one or more regions of interest in pathology imaging applications, such as, but not limited to, tumor detection, rare cell detection, gene-based tests, such as fluorescence in-situ hybridization (FISH), protein based tests, or combinations thereof, for diagnostic and research purposes. In one example, optical responses provided by the biological sample during imaging may be stored in a memory, for example, a memory of a signal processing unit of an imaging system employing the ultra-compact microscope. In one embodiment, rare cell detection may include detection of rarely occurring cells in peripheral blood streams and body fluids. In one example, it may be desirable to detect and extract rare fetal cells from a maternal blood stream for prenatal care.

As will be appreciated, detection of cancerous cells of otherwise concealed malignant tumors is highly desirable for early diagnosis of cancer, cancer therapy, monitoring, and characterization of a type and stage of cancer. It may be noted that the cancerous cells from malignant tumors may be dispersed in the blood stream. In one embodiment, the ultra-compact microscope may be used to detect cancerous cells in the blood stream that may otherwise be accessible only via invasive surgical procedures. Moreover, in another embodiment, the ultra-compact microscope may be configured to perform genetic screening applications. The genetic screening may be desirable for identifying gene alterations in an effective and time efficient manner using the ultra-compact microscope. For example, FISH analysis may be performed on biological samples to diagnose Down's syndrome in prenatal applications. Further, in one embodiment, the ultra-compact microscope may be configured to perform screening for protein-based tests. The protein-based tests may use immunoassays or immunohistochemistry that may detect proteins (e.g., antigens or antibodies). Further, the antigens and antibodies may indicate the presence of an organism in the biological sample. The organism may be friendly (e.g., fetal cells), or unfriendly (a pathogen such as a virus or bacterium).

Advantageously, the ultra-compact microscope is configured to provide autofocusing during imaging of the biological sample. By way of example, the ultra-compact microscope is configured to provide autofocusing using dynamic translational motion and/or dynamic tilting motion using an image sensor that is configured to acquire image data from the biological sample. Unlike traditional microscopes where focusing is achieved by translating an objective lens of the traditional microscope, in the present specification, the image sensor of the ultra-compact microscope is dynamically translated or tilted with respect to the surface of the biological sample to provide autofocusing. Further, the translational and/or tilting motion of the image sensor may also provide 3D imaging of the biological sample. Advantageously, the dynamic translation and/or dynamic tilting capability of the image sensor during scanning and imaging of the biological sample provides a 3D image of the biological sample based on a single image acquisition.

In certain embodiments, the ultra-compact microscope includes a small footprint and a light weight design. In a particular example, the ultra-compact microscope may be configured to acquire 3D images of the biological sample based on a single image acquisition while enhancing or at least maintaining industrial parameters pertaining to a field of view, resolution, magnification parameters. Further, it may be noted that scanning the light weight ultra-compact microscope over the surface of the biological sample results in reduced transient response time (relative to traditional microscopes) for autofocusing, thereby increasing the throughput of the ultra-compact microscope and/or an imaging system employing the ultra-compact microscope.

In some embodiments, the ultra-compact microscope may employ a software platform that facilitates automation of operations of the ultra-compact microscope, such as, but not limited to, image focusing, image sensor adjustment, and image acquisition as well as analysis. Moreover, the ultra-compact design of the ultra-compact microscope provides high mechanical speed with a very low transient settling time.

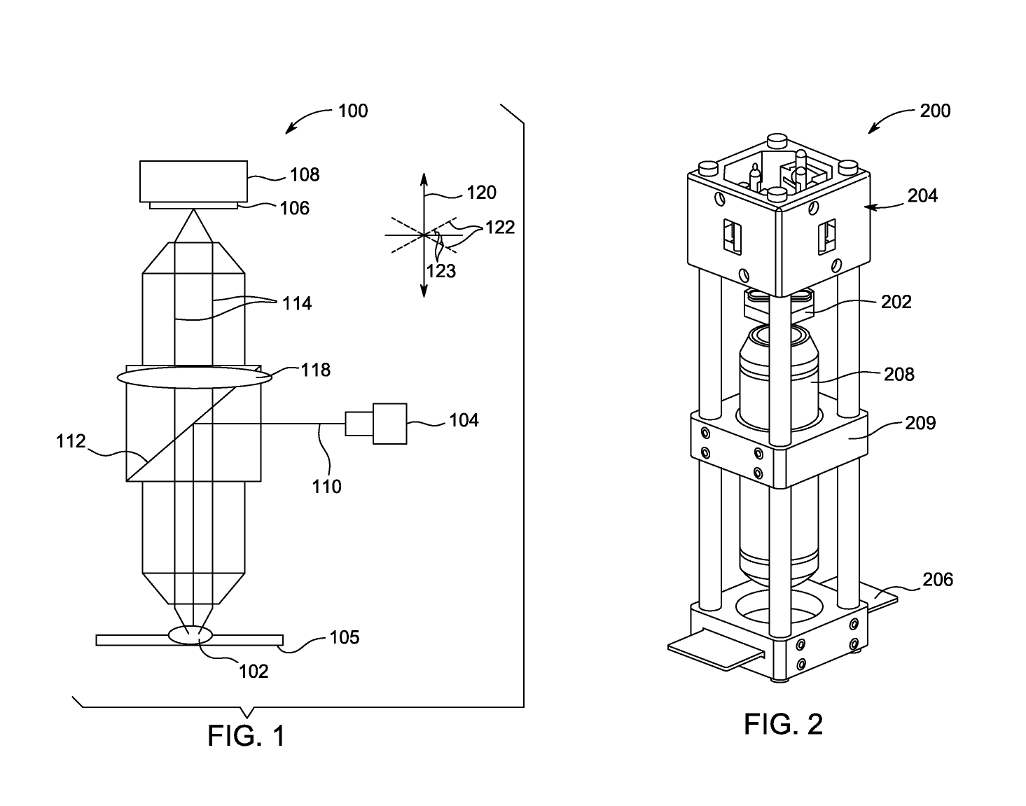

FIG. 1 illustrates an exemplary ultra-compact microscope 100 of the present specification. In some embodiments, the ultra-compact microscope 100 is used for imaging a biological sample 102 to identify one or more regions of interest. Further, the regions of interest may be portions in the sample 102 that demonstrate optical responses such as, but not limited to, absorption, fluorescence intensity, scattering, or combinations thereof. In one example, the ultra-compact microscope 100 may be used to image the biological sample 102 to provide an estimate of constituents present in the biological sample 102. Further, the ultra-compact microscope 100 may also be used to provide high content cellular analysis to identify regions of interest in the biological sample 102. Moreover, it may be noted that the biological sample 102 may include solid samples, fluidic samples, samples with regular surfaces, samples with irregular surfaces, samples with a regular volume, samples with irregular volumes, or combinations thereof. Non-limiting examples of the biological sample 102 may include tissue samples, blood samples, body fluids, or combinations thereof.

In the illustrated embodiment, the ultra-compact microscope 100 includes an illumination source 104, an image sensor 106 and a micro-motion control assembly 108. In certain embodiments, the illumination source 104 may include a single illumination source or a plurality of illumination sources. Non-limiting examples of the illumination source 104 may include a laser source, a light emitting diode (LED), an incandescent lamp, an arc lamp, or combinations thereof. Further, the illumination source 104 may be configured to provide illumination beams, generally represented by reference numeral 110, to excite at least a portion of the biological sample 102 disposed on an analysis surface 105. Moreover, the illumination source 104 may be configured to provide single or multiple wavelength illumination beams. In case of fluorescent imaging, the illumination source 104 may include a monochromatic illumination source. However, in case of bright field imaging, a white light illumination source, such as, but not limited to, a white light LED, or a white light laser may be used as the illumination source 104. While in the illustrated embodiment, the analysis surface 105 is depicted as being a part of the ultra-compact microscope 100, it may be noted that in some other embodiments, the analysis surface 105 may not be a part of the ultra-compact microscope. In some of these embodiments, the analysis surface 105 may be external to the ultra-compact microscope 100.

In certain embodiments, the image sensor 106 of the ultra-compact microscope 100 is configured to receive signals emitted by the biological sample 102 in response to the incident illumination beams 110 provided by the illumination source 104. Moreover, the illumination beams 110 from the illumination source 104 may be directed to the biological sample 102 using optics, such as a dichroic mirror 112. Further, excitation or emitted signals 114 (e.g., fluorescent emitted signals) may be collected by the image sensor 106 to form an image of at least a portion of the biological sample 102. In the illustrated embodiment, the emitted signals 114 may be collected using an objective lens 118. Further, the collected emitted signals 114 are transferred to the image sensor 106. In one example, the emitted signals 114 may be transmitted from the biological sample 102 to the image sensor 106 using fiber optics. In one embodiment, the analysis surface 105 on which the biological sample 102 is disposed may be positioned near a focal plane of the objective lens 118 to provide focused images to the image sensor 106.

Moreover, in certain embodiments, the micro-motion control assembly 108 of the ultra-compact microscope 100 is designed to provide at least one dimensional motion to the image sensor 106. In particular, the micro-motion control assembly 108 may be configured to facilitate movement of the image sensor 106 in directions perpendicular to the plane of the analysis surface 105. These directions perpendicular to the plane of the analysis surface 105 are generally represented by reference numeral 120. By way of example, when the image sensor 106 moves up, the image sensor 106 is displaced farther away from the biological sample 102, and when the image sensor 106 moves down, the image sensor 106 is displaced closer to the biological sample 102. In addition to the translational up and down movements of the image sensor 106, the micro-motion control assembly 108 is also configured to facilitate tilting of the image sensor 106. In the illustrated embodiment, the tilting movement of the image sensor 106 is generally represented by reference numeral 122. Further, the image sensor 106 may be tilted at different angles 123.

Advantageously, tilting the image sensor 106 with respect to the analysis surface 105 or the biological sample 102 facilitates imaging of the biological sample 102 in the directions 120. In one example, an angle 123 of tilt of the image sensor 106 may be gradually increased or decreased to scan a dimension of the biological sample along the directions 120. Further, the translational and tilting motions of the image sensor 106 facilitate autofocusing of the ultra-compact microscope 100. In addition, the translational motion and the tilting motion of the image sensor 106 may be performed simultaneously while scanning or imaging of the biological sample 102. Accordingly, the translational motion and the tilting motion may be referred to as dynamic motion as the position and/or orientation of the image sensor 106 may be changed during imaging of the biological sample 102. In some embodiments, the dynamic motion facilitates acquiring 3D images of the biological sample 102 in a single image acquisition. As will be described in detail with respect to FIGS. 2-4, in some embodiments, the micro-motion control assembly 108 may include a plurality of actuators (not shown in FIG. 1) that are operatively coupled to the image sensor 106. The actuators are configured to facilitate the dynamic translational motion as well as the dynamic tilting motion of the image sensor 106.

As will be appreciated, conventionally, microscopes accomplish optimal focusing along a direction perpendicular to a plane of a corresponding analysis surface by displacing an objective lens of the microscope. This displacement of the objective lens along the direction perpendicular to the plane of the analysis surface 105 is generally provided by a mechanical stage or a piezo-actuated objective, which adds cost and volume to the system. As noted hereinabove, in certain embodiments, the micro-motion control assembly 108 is operatively coupled to the image sensor 106 to facilitate dynamic position adjustment of the image sensor 106. In one embodiment, the ultra-compact microscope 100 may be configured to scan a slide on which the biological sample 102 is disposed without compromising field of view, resolution or magnification parameters used by industry. Advantageously, the design of the ultra-compact microscope 100 is compact and configured to provide high mechanical speed with exceptionally low transient settling time as compared to existing microscopes.

In some embodiments, the image sensor 106 may be a semiconductor based image sensor that is configured to convert an optical image into an electronic signal. In one embodiment, the image sensor 106 may be a complementary metal-oxide-semiconductor (CMOS) image sensor, N-type metal-oxide-semiconductor (MOS) or NMOS image sensor, live MOS, or combinations thereof. In another embodiment, the image sensor 106 may include a combination of a MOS image sensor and a charge coupled device (CCD) image sensor. In one embodiment, the CMOS image sensor may be coupled to an imaging substrate of the CCD image sensor. Advantageously, the CMOS image sensor may be implemented in the ultra-compact microscope 100 in a simple assembly using relatively fewer components, thereby contributing to a smaller footprint of the ultra-compact microscope 100. Further, the CMOS image sensor may utilize relatively lower power as compared to other image sensors. Moreover, the CMOS image sensor may provide relatively faster readout as compared to conventional image sensors. Additionally, the CMOS image sensor is cost effective.

In a particular example, the ultra-compact microscope 100 may have a volume footprint of about 5 cm×5 cm×15 cm. Further, in one embodiment, the ultra-compact microscope 100 having the imaging sensor 106 and the actuators may have a weight of less than about 20 grams. Moreover, the ultra-compact microscope 100 may be a stand-alone unit or an add-on module for commercially available or other microscopes for automated localization of cells and tissue events of interest. Also, in some embodiments, the ultra-compact microscope 100 may be integrated with existing systems for mounting the biological sample 102. By way of example, the ultra-compact microscope 100 may be integrated with movable sample stages (for example, linear stages) for mounting the biological sample. Advantageously, the ultra-compact microscope 100 of the present specification may be a hand-held device.

FIG. 2 illustrates a perspective view of an ultra-compact microscope 200 of the present application. In the illustrated embodiment, the ultra-compact microscope 200 includes an illumination source (not shown in FIG. 2), an image sensor 202, a micro-motion control assembly 204, an analysis surface 206, and an optics assembly 208. Further, in one embodiment, the illumination source may be disposed inside the structure represented by reference numeral 209. In the illustrated embodiment, the optics assembly 208 may include optical elements configured to direct an illumination beam (not shown in FIG. 2) originating from the illumination source to the analysis surface 206. Non-limiting examples of the optical elements include tube lens, fiber optics, dichroic mirror, or combinations thereof. Moreover, the optics assembly 208 includes an objective lens (not shown in FIG. 2). In operation, the objective lens may be configured to collect emitted signals emitted by a biological sample (not shown in FIG. 2) in response to the incident illumination beams. Further, the optics assembly 208 may be configured to direct the emitted signals collected from the biological sample to the image sensor 202. In one example, the collected emitted signals may be transmitted to the image sensor 202 using fiber optics (not shown in FIG. 2). It may be noted that the structure of the ultra-compact microscope 200 of FIG. 2 may be disposed in a suitable casing to provide mechanical integrity, strength and robustness to the ultra-compact microscope 200.

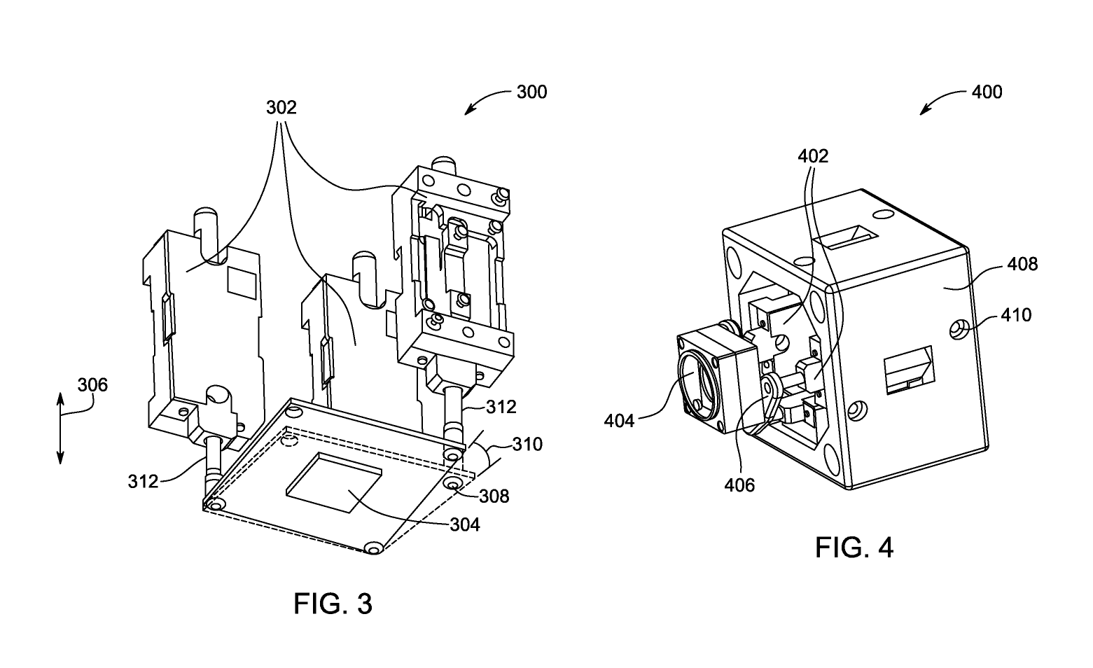

FIG. 3 illustrates a perspective view of a portion 300 of a micro-motion control assembly, such as the micro-motion control assembly 204 of FIG. 2. The portion 300 of the micro-motion control assembly includes a plurality of actuators 302 that is operatively coupled to an image sensor 304. Further, the actuators 302 may be configured to provide one or more motions to the image sensor 304 in one or more directions. In particular, the actuators 302 may be configured to provide translational and/or tilting motions to the image sensor 304. In the illustrated non-limiting example, a tilted position of the image sensor 304, tilted at an angle 310 is represented by reference numeral 308. Further, in some embodiments, the actuators 302 of the micro-motion control assembly 300 may be configured to work in tandem and co-operatively to enable movement of the image sensor 304 in directions represented by arrows 306 and/or tilt of the image sensor 304. The translational movement of the image sensor 304 along the directions 306 and/or the tilt of the image sensor 304 enables acquisition of 3D images of the biological sample based on a single image acquisition. Also, the translational movement of the image sensor 304 along the directions 306 and/or tilt of the image sensor 304 facilitate obtaining additional depth information. In certain embodiments, an amount of translational displacement in the directions 306 or the angle 310 of tilt of the image sensor 304 may be adjusted by manipulating lengths of actuators arms 312 of individual actuators 302.

In one embodiment, the plurality of actuators 302 may include 3 actuators. Non-limiting examples of the actuators 302 may include one or more linear translation actuators, piezoelectric actuators, micro-electro mechanical system (MEMS) actuators, or combinations thereof. In one embodiment, three linear translation actuators may be coupled close to three respective corners of the image sensor 304. Further, the actuators 302 of the plurality of actuators 302 may be same or different in a structural and/or functional manner. By way of example, at least one of the actuator 302 may be functionally and/or structurally different from the other actuators 302. In a non-limiting example employing three linear translation actuators, each linear translation actuator of the three linear translation actuators may push and/or pull respective corners of a square shaped CMOS image sensor in the directions 306 thereby enabling translational and/or tilting motion of the image sensor 304 to facilitate fine focusing of the ultra-compact microscope.

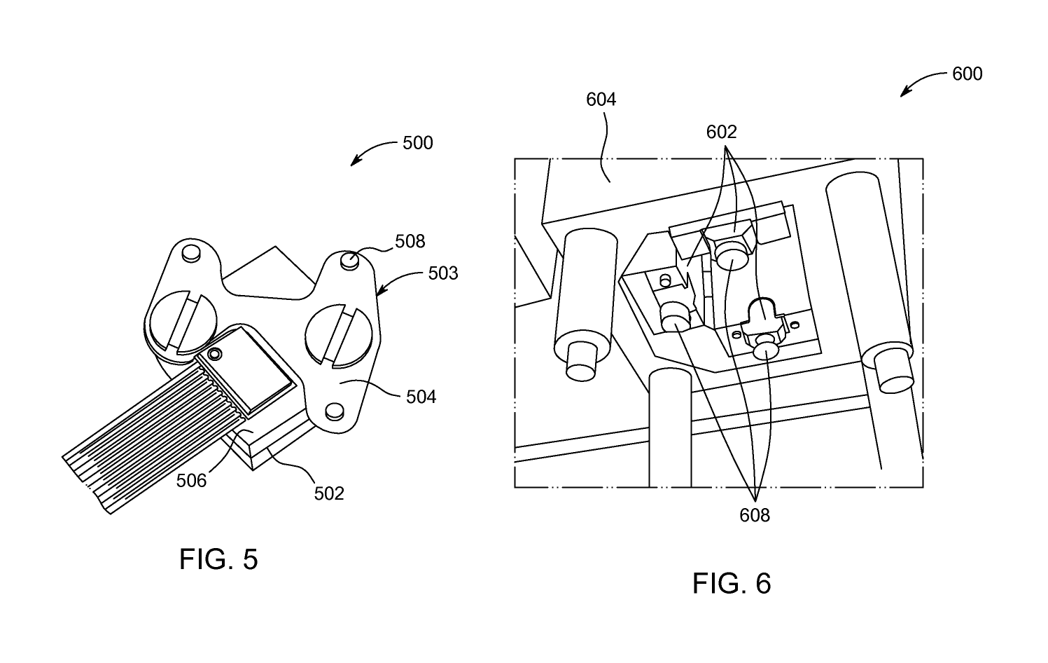

Turning now to FIG. 4, a perspective view of an exemplary micro-motion control assembly 400 is depicted. In the illustrated embodiment of the micro-motion control assembly 400, one or more actuators 402 of the plurality of actuators 402 may be operatively coupled to an image sensor 404 using one or more flexible magnetic couplers 406. The flexible magnetic coupler 406 is configured to allow and facilitate movement of the image sensor 404 while maintaining a physical coupling between the image sensor and the actuators 402. In one embodiment, the flexible magnetic coupler 406 disposed between the actuators 402 and the image sensor 404 may be similar in functioning to a ball joint. However, the flexible magnetic coupler 406 is relatively compact and lightweight as compared to a conventional ball joint. This flexible magnetic coupler 406 will be explained in greater detail with respect to FIGS. 5-7. In some embodiments, the plurality of actuators 402 may be disposed in an actuator housing 408. The actuator housing 408 is configured to house at least a portion of the actuators 402. Further, the actuator housing 408 is configured to provide mechanical integrity to the micro-motion control assembly 400. In addition, the actuator housing 408 may include provisions, such as a receptacle 410, to conveniently couple the actuator housing 408 to its respective ultra-compact microscope (not shown in FIG. 4).

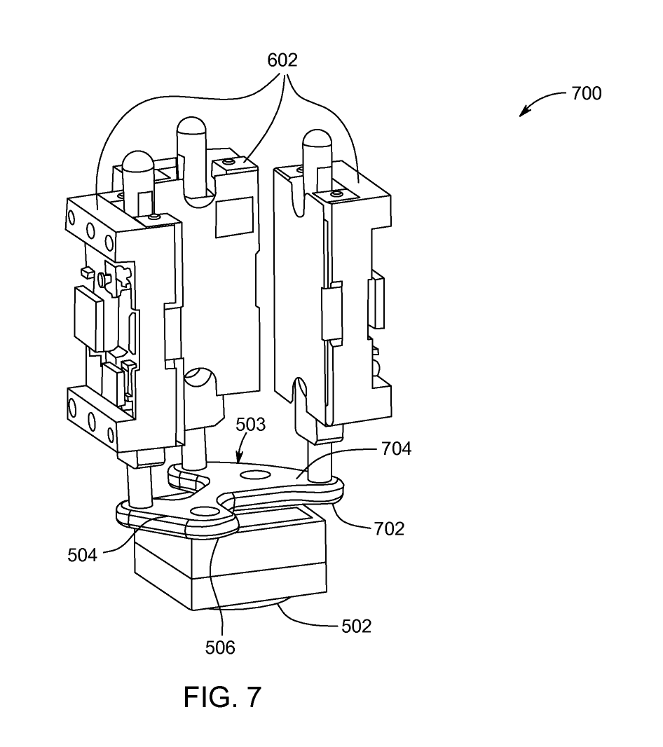

Referring now to FIGS. 5-7, a schematic representation 500 of a step of a method for operatively coupling an image sensor 502 (see FIG. 5) to a plurality of actuators 602 (see FIGS. 6-7) using a flexible magnetic coupler 503 is illustrated. In particular, FIG. 5 illustrates the flexible magnetic coupler 503 having an adapter 504 and a plurality of magnet heads 508. The flexible magnetic coupler 503 is configured to allow translational and/or tilting motions of the image sensor 502, while maintaining a physical coupling between the image sensor 502 and the plurality of actuators 602. Further, the adapter 504 of the flexible magnetic coupler 503 is coupled to a surface 506 of the image sensor 502. In a particular example, the adapter 504 may be coupled to the surface 506 of the image sensor 502 using an adhesive bonding, however, other types of bonding mechanisms, such as mechanical or thermal bonding mechanisms may also be used to couple the adapter 504 and the image sensor 502. Further, although in some embodiments, the flexible magnetic coupler 503 may be pre-assembled, in some other embodiments, the flexible magnetic coupler 503 may be provided in the form of individual components, such as the adapter 504 and a plurality of magnet heads 508. In these embodiments where the flexible magnetic coupler 503 is not pre-assembled, the adapter 504 may include a plurality of slots (not shown) configured to receive the plurality of magnet heads 508.

Further, as illustrated in a perspective view 600 of FIG. 6, each actuator 602 of the plurality of actuators 602 is disposed in an actuator housing 604. Additionally, as illustrated in FIG. 6, a distal end 608 of each of the actuators 602 of the plurality of actuators 602 is configured to be coupled to the magnet heads 508 (see FIG. 5) using magnetic forces present between the distal ends 608 of the actuators 602 and the magnet heads 508.

Turning now to FIG. 7, a perspective view of a micro-motion control assembly 700 having the image sensor 502 (see FIG. 5) coupled to the plurality of actuators 602 (see FIG. 6) using the flexible magnetic coupler 503 (see FIG. 5) is depicted. Further, a first side 702 of the adapter 504 (see FIG. 5) of the flexible magnetic coupler 503 is coupled to the image sensor 502. Moreover, a second side 704 of the adapter 504 is coupled to the actuators 602. In particular, the magnet heads 508 of the flexible magnetic coupler 503 are attached to the distal ends 608 of the actuators 602 on the second side 704 of the adapter 504. Advantageously, the flexible magnetic coupler 503 disposed between the image sensor 502 and the actuators 602 is a physically flexible coupler that facilitates the motion of the actuators 602 while maintaining physical coupling between the actuators 602 and the imaging sensor 502. Moreover, the flexible magnetic coupler 503 facilitates accurate image acquisition by insuring that the image sensor 502 is centered along an optical axis of the objective lens of the ultra-compact microscope.

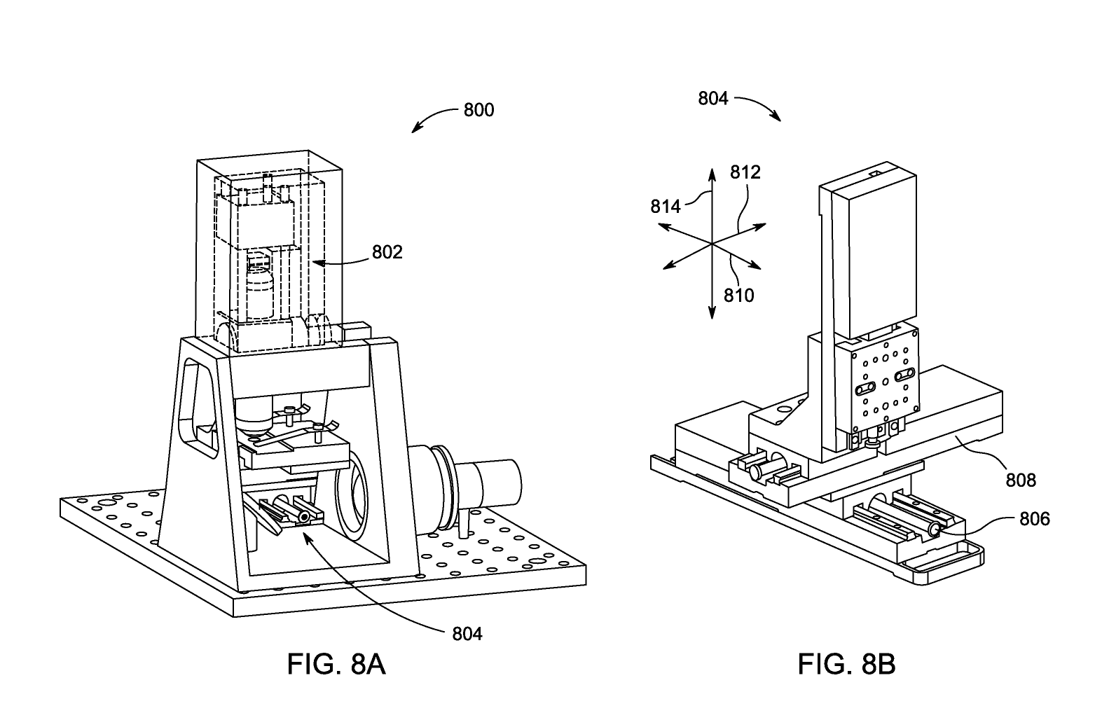

In certain embodiments, the ultra-compact microscope of the present specification may be retro-fitted or coupled to conventional microscope systems. FIGS. 8A-8B illustrate an exemplary embodiment of an integrated system 800 having an ultra-compact microscope 802 of the present specification operatively coupled to a sample stage 804 of a conventional microscope. The sample stage 804 may include one or more linear stages. In the illustrated embodiment, the sample stage 804 includes two linear stages 806 and 808 that are configured to facilitate movement of a sample in two or more directions represented generally by reference numerals 810 and 812, respectively.

In some embodiments, the linear stages 806 and 808 may be used to provide coarse image focusing, whereas, a micro-motion control assembly (not shown in FIGS. 8A-8B) of the ultra-compact microscope 802 may be used to provide fine image focusing by using fine position control along the direction 814, and dynamic tilting capability for an image sensor of the ultra-compact microscope 802. The dynamic tilting of the image sensor during scanning of the biological sample by the ultra-compact microscope 802 provides additional depth information of the biological sample, thereby providing a 3D image of the biological sample based on a single image acquisition.

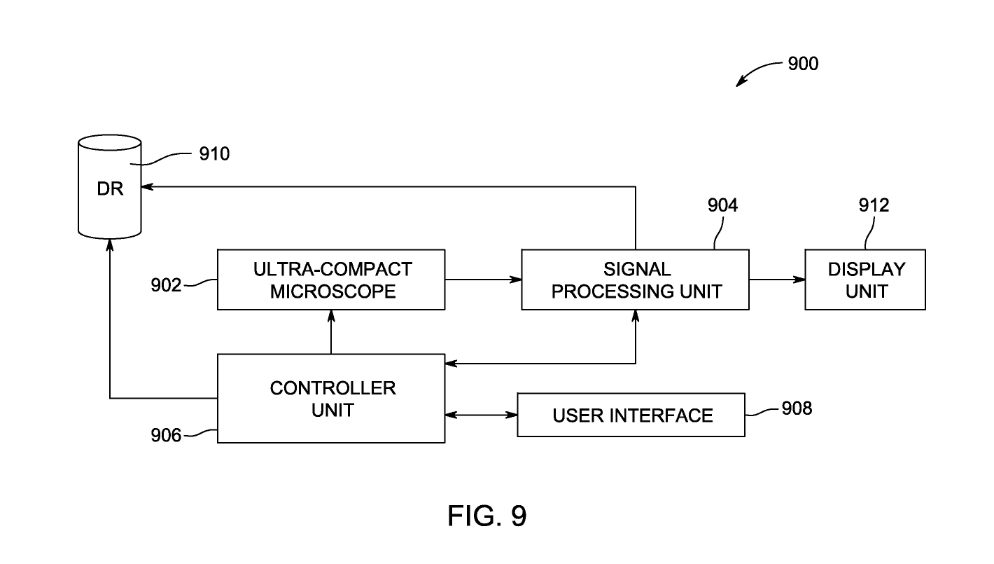

FIG. 9 illustrates an exemplary imaging system 900 for imaging a biological sample. The imaging system 900 includes an ultra-compact microscope 902. Further, the imaging system 900 includes a signal processing unit 904 operatively coupled to the ultra-compact microscope 902 and configured to process image signals received by an image sensor (not shown in FIG. 9) of the ultra-compact microscope 902. Further, the imaging system 900 includes a controller unit 906 configured to control a micro-motion control assembly (not shown in FIG. 9) of the ultra-compact microscope 902. In addition, the controller unit 906 may be operatively coupled to the ultra-compact microscope 902. In particular, the controller unit 906 may be operatively coupled to the micro-motion control assembly of the ultra-compact microscope 902 and configured to provide user inputs that are received via a user interface 908.

Further, the signal processing unit 904 of the imaging system 900 may be configured to process data received by the signal processing unit 904 from the controller unit 906. In certain embodiments, the signal processing unit 904 and/or the controller unit 906 may be coupled to one or more user input-output devices of the user interface 908 for receiving commands and inputs from a user. The user interface 908 may include devices such as, but not limited to, a keyboard, a touchscreen, a microphone, a mouse, a control panel, a display device, a foot switch, a hand switch, a button, or combinations thereof. Although not illustrated, in one embodiment, the signal processing unit 904 and the controller unit 906 may be integrated into a single unit. By way of example, the signal processing unit 904 and the controller unit 906 may share a common processor. In some embodiments, the signal processing unit 904 and/or the controller unit 906 may be configured to store the related data in a storage repository 910. In one embodiment, the storage repository 910 may include devices such as a hard disk drive, a floppy disk drive, a compact disk-read/write (CD-R/W) drive, a digital versatile disc (DVD) drive, a flash drive, and/or a solid-state storage device. Further, the imaging system 900 may include a display unit 912 that is configured to display data representative of the progress of the imaging process as images or a sequence of images.

The aforementioned components, such as the signal processing unit 904 and/or the controller unit 906 may be dedicated hardware elements such as circuit boards with digital signal processors or may be software running on a general-purpose computer or processor such as a commercial, off-the-shelf personal computer (PC). Further, the various components may be combined or separated according to various embodiments of the present specification. Thus, those skilled in the art will appreciate that the present imaging system 900 is provided by way of example, and the present specifications are in no way limited by the specific system configuration.

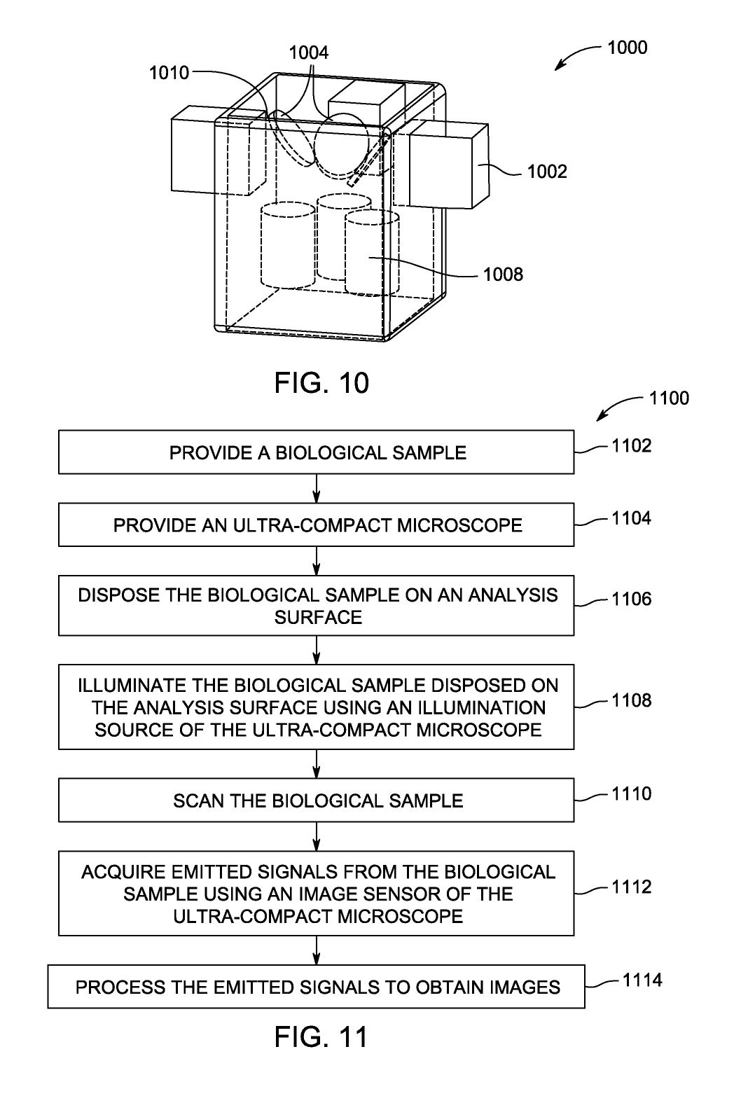

FIG. 10 illustrates an exemplary embodiment of a portion of a multi-head ultra-compact microscope 1000. The multi-head ultra-compact microscope 1000 includes a plurality of image sensors 1002. Further, the multi-head ultra-compact microscope 1000 includes minors 1004 that are operatively coupled to the image sensors 1002. The mirrors 1004 may be operatively coupled to a respective optical lens array 1008 that is configured to direct illumination beams from an illumination source (not shown in FIG. 10) to at least a portion of a biological sample (not shown in FIG. 10), and collect emitted signals from at least the portion of the biological sample. Further, the optical lens array 1008 may be configured to transmit the emitted signals collected from the biological sample to the image sensors 1002.

In some embodiments, the image sensors 1002 may be operatively coupled to an optical wavelength filter 1010. In one example, each image sensor 1002 may be coupled to a wavelength filter 1010 that is configured to filter light beams having a wavelength that is different from wavelengths of the other wavelength filters 1010. Hence, each image sensor 1002 may be configured to image at a particular wavelength. In some embodiments, one or more images sensors 1002 of the plurality of image sensors 1002 may be monochromatic image sensors that are configured to acquire and/or process electrical signals pertaining to emitted signals from a particular wavelength.

In certain embodiments, the ultra-compact microscope 1000 of the present specification may be used in bright field imaging, fluorescence imaging, epi-fluorescence imaging, or combinations thereof. By way of example, in the case of bright field imaging, a white LED may be used as an illumination source. In a particular example, each optical path corresponding to the three image sensors 1002 may include a miniature monochromatic sensor, a tube lens, a color filter, and an objective lens. Different wavelength illumination sources along with emission filters may be used for fluorescent imaging. Moreover, dichroic mirrors and emission filters may be removed for bright field imaging.

Further, in the illustrated embodiment, in the case of fluorescent imaging, the 3 parallel optical paths may be implemented using 3 monochromatic LEDs. Moreover, each optical path may include a corresponding monochromatic image sensor, tube lens for guiding the light from the biological sample to the image sensor, a color filter, and an objective lens.

FIG. 11 illustrates an exemplary flow chart 1100 for a method of imaging a biological sample. At step 1102, a biological sample is provided. In one embodiment, the biological sample may be pre-process before imaging. By way of example, the biological sample may be rinsed in a suitable buffer, and then stained with anti-bodies responsible for fluorescence. After antibody staining, the biological sample cells may be disposed in a suspension medium. In one embodiment, the suspension medium may be a gelatable and polymerizable medium.

At step 1104, an ultra-compact microscope of the present specification may be provided. Further, at step 1106, the biological sample may be disposed on an analysis surface of the ultra-compact microscope. Alternatively, the biological sampled may be disposed on a surface that is external to the ultra-compact microscope. By way of example, the biological sample may be disposed on a sample stage, such as a sample stage of a conventional microscope.

Next, at step 1108, the biological sample disposed on the analysis surface may be illuminated using an illumination source of the ultra-compact microscope. In case of fluorescence imaging, the biological sample may be illuminated with light of a specific wavelength (or wavelengths) which may be absorbed by the fluorophores, causing the fluorophores to emit light of longer wavelengths (i.e., of a different color than the absorbed light). The illumination light may be separated from the much weaker emitted fluorescence through the use of a spectral emission filter.

Further, at step 1110, the ultra-compact microscope may be scanned relative to the biological sample to achieve a sharply focused image. In particular, the translational and/or tilting motion of an image sensor is used to scan the biological surface in a 3D fashion. Advantageously, the dynamic translation and/or tilting motions of the image sensor during scanning provides a 3D image of the biological sample based on a single image acquisition. It may be noted that scanning the light weight ultra-compact microscope on the biological sample reduces the transient response of the autofocusing, thereby increasing the throughput. Further, the ultra-compact design of the ultra-compact microscope provides a portable platform for a wide range of high throughput screening, without compromising the performance of the ultra-compact microscope. In one embodiment, the ultra-compact microscope may be held in hand for scanning a surface of a biological sample. However, other variations, like use of a robotic arm, are also envisioned within the scope of the present specification. In this embodiment, the analysis surface on which the biological sample is disposed may not form part of the ultra-compact microscope. In particular, the analysis surface may be external to the ultra-compact microscope.

At step 1112, emitted signals from the biological sample may be acquired by the image sensor of the ultra-compact microscope. Further, step 1112 of acquiring the emitted signals may also include the step of autofocusing that may include dynamic motions of the image sensor.

Moreover, at step 1114, the emitted signals from the biological sample acquired by the image sensor may be processed to obtain images. Optionally, the processed data and/or images may be displayed on a display unit such as the display unit 912 of FIG. 9. In one embodiment, the processed data may be stored or transferred to a memory device or any other relevant device. In one embodiment, the processed data may be stored on a hard disk or read-write magneto optic disk, or transmitted to the device using a data line or wireless communication medium. Further, in some embodiments, along with image acquisition, the method may also include image analysis. Steps 1112 and 1114 may be automated by providing instructions to the ultra-compact microscope or the imaging system by the user. Moreover, the instructions may be pre-fed to the ultra-compact microscope or the imaging system, or may be provided at the time of use of the ultra-compact microscope or the imaging system. Accordingly, it may be noted that the method of imaging the biological sample using the ultra-compact microscope of the present specification may be automated. By way of example, the method 1100 of FIG. 11 may be automated. Further, commands may be provided to the imaging system, such as the imaging system 900 of FIG. 9 using an external device, such as a computer, to control or command the imaging system 900. By way of example, after providing the biological sample and the ultra-compact microscope, commands from a signal processing unit and/or a controller unit may be provided to the imaging system to direct the system to perform imaging.

Advantageously, the ultra-compact microscope of the present specification is a compact and light weight microscope that is capable of performing 3D imaging of the biological sample. Further, the ultra-compact microscope is configured to provide a sufficient field of view (for example, a field of view of about 1 mm×1 mm), resolution (for example, resolution of less than about 1 micron) as well as magnification as used by the industry. Moreover, the image sensor used in the ultra-compact microscope provides substantial cost reduction and a reduced foot print for automated microscopy applications, such as whole slide scanning Additionally, using the light weight image sensor enhances the transient response of autofocusing, thereby resulting in enhanced throughput of the ultra-compact microscope. Also, the ultra-compact design of the ultra-compact microscope offers a portable platform for a wide range of high throughput screening, without forfeiting performance or image quality.

While only certain features of the disclosure have been illustrated and described herein, many modifications and changes will occur to those skilled in the art. It is, therefore, to be understood that the appended claims are intended to cover all such modifications and changes as fall within the true spirit of the disclosure.

1. An ultra-compact microscope configured to image at least a portion of a biological sample, comprising:
an illumination source configured to provide illumination beams to image at least the portion of the biological sample;
an image sensor configured to acquire emitted signals from at least the portion of the biological sample;
an objective lens operatively coupled to the image sensor and configured to direct emitted signals from the biological sample to the image sensor; and
a micro-motion control assembly operatively coupled to the image sensor and configured to provide dynamic translational motion, dynamic tilting motion, or both to the image sensor at least during scanning of the biological sample.

2. The ultra-compact microscope of claim 1, wherein the image sensor comprises a complementary metal-oxide-semiconductor (CMOS) image sensor.

3. The ultra-compact microscope of claim 1, wherein the micro-motion control assembly comprises a plurality of actuators.

4. The ultra-compact microscope of claim 3, wherein one or more actuators of the plurality of actuators are linear actuators.

5. The ultra-compact microscope of claim 3, wherein the plurality of actuators are coupled to the image sensor using a flexible magnetic coupler.

6. The ultra-compact microscope of claim 5, wherein the flexible magnetic coupler comprises an adapter and a plurality of magnet heads.

7. The ultra-compact microscope of claim 6, wherein the plurality of magnet heads is configured to be operatively coupled to distal ends of one or more actuators of the plurality of actuators.

8. The ultra-compact microscope of claim 1, further comprising a dichroic mirror, an optical wavelength filter, an objective lens, or combinations thereof.

9. An imaging system for imaging at least a portion of the biological sample, comprising:
an ultra-compact microscope, comprising:
an illumination source configured to provide illumination beams to image at least the portion of the biological sample;
an image sensor configured to acquire emitted signals from at least the portion of the biological sample;
an objective lens operatively coupled to the image sensor and configured to direct the emitted signals from the biological sample to the image sensor;
a micro-motion control assembly operatively coupled to the image sensor and configured to provide dynamic translational motion, dynamic tilting motion, or both to the image sensor at least during scanning of the biological sample;
a signal processing unit operatively coupled to the ultra-compact microscope and configured to process the emitted signals acquired by the image sensor; and
a controller unit configured to control the micro-motion control assembly.

10. The imaging system of claim 9, wherein the ultra-compact microscope is a multi-head ultra-compact microscope.

11. The imaging system of claim 10, wherein the multi-head ultra-compact microscope comprises a plurality of optical paths.

12. The imaging system of claim 11, comprising a plurality of image sensors, wherein each optical path of the plurality of optical paths is operatively coupled to a corresponding image sensor of the plurality of image sensors.

13. The imaging system of claim 10, wherein the multi-head ultra-compact microscope comprises a plurality of illumination sources.

14. The imaging system of claim 13, wherein each illumination source of the plurality of illumination sources is a monochromatic light emitting diode or a white light emitting diode.

15. The imaging system of claim 9, wherein the micro-motion control assembly comprises a plurality of actuators and a flexible magnetic coupler.

16. The imaging system of claim 15, wherein the image sensor is operatively coupled to the plurality of actuators using the flexible magnetic coupler.

17. The imaging system of claim 9, wherein the ultra-compact microscope is operatively coupled to one or more linear stages to form an integrated imaging system.

18. A method for imaging a biological sample, comprising:
providing a biological sample disposed on an analysis surface;
providing an ultra-compact microscope operatively coupled to the analysis surface;
illuminating at least a portion of the biological sample using an illumination source of the ultra-compact microscope;
scanning at least a portion of the biological sample using an image sensor and a micro-motion control assembly of the ultra-compact microscope;
acquiring emitted signals from at least the portion of the biological sample by the image sensor of the ultra-compact microscope; and
processing the acquired emitted signals to form an image of at least the portion of the biological sample.

19. The method of claim 18, wherein the step of scanning comprises dynamically translating the image sensor, dynamically tilting the image sensor, or both.

20. The method of claim 18, wherein dynamically translating the image sensor, dynamically tilting the image sensor, or both comprises controlling one or more actuators of a plurality of actuators of the ultra-compact microscope.
